(19) United States
(12) Patent Application Publication
(10) Pub. No.: US 2022/0301421 A1
(43) Pub. Date: Sep. 22, 2022

(54) DECOMPOSITION METHOD FOR TRAFFIC FLOW CHARACTERISTIC MODES BASED ON GENERATION-FILTERING MECHANISM

(71) Applicant: NANJING NORMAL UNIVERSITY, Jiangsu (CN)

(72) Inventors: Linwang YUAN, Jiangsu (CN); Zhaoyuan YU, Jiangsu (CN); Xu HU, Jiangsu (CN); Dongshuang LI, Jiangsu (CN); Wen LUO, Jiangsu (CN)

(73) Assignee: NANJING NORMAL UNIVERSITY, Jiangsu (CN)

(21) Appl. No.: 17/607,407

(22) PCT Filed: Nov. 20, 2020
(86) PCT No.: PCT/CN2020/130411

§ 371 Date: Oct. 29, 2021

(30) Foreign Application Priority Data
Nov. 17, 2020 (CN) 202011284157.3

(51) Int. Cl. G08G 1/01; G06N 10/60

(52) U.S. Cl. CPC G08G 1/0129; G08G 1/0133; G08G 1/0145; G06N 10/60

(57) ABSTRACT

The present invention discloses a characteristic modes decomposition method for traffic volume based on generation-filtering mechanism, which includes: firstly, the expressway traffic flow is regarded as a closed traffic system. According to the randomness of drivers, each driver is regarded as a separate particle to simulate its trajectory, and then the corresponding traffic modes are obtained according to the probability distribution of the trajectory under different parameters; secondly, taking different parameters of the quantum walk, the time evolution of the probability distribution of the traffic volume caused by different driving patterns at a station is obtained, and then performing the same for other different stations to generate a set of expressway traffic mode set; and finally, according to observed traffic volume data, the generated traffic modes are screened to inverse the mode structures of traffic volume.

### TECHNICAL FIELD

The present invention relates to the fields of urban planning and traffic geography, and particularly relates to a characteristic modes decomposition method for traffic volume based on generation-filtering mechanism.

### BACKGROUND

Traffic volume is an important indicator of many traffic applications, it is commonly obtained from traffic sensors at exits and entrances of expressway. Traffic volume is the primary carrier for drivers of varying characteristics, with complexity and structural features depending on the driving patterns of the drivers. Assuming that driving trajectories with the same or similar driving patterns aggregate to form a traffic mode, the complex traffic mode represented by overtaking leads to drastic changes in the traffic volume and shows strong randomness, while the simple traffic mode exemplified by constant-speed driving has little influence on the traffic volume, and the driving-into/off traffic volumes are relatively similar. However, the real traffic flow is not a simple combination of one or more traffic modes, but a “mixture” formed by aliasing of many traffic modes of varying complexity, which is a major challenge for modeling, simulation, prediction and the like of the traffic flow.

The existing characteristic modes decomposition method for traffic volume are mainly based on the perspective of macro statistical analysis, and performs decomposition and analysis for the characteristics of traffic volume by multi-scale analysis. Current multi-scale analysis of the traffic volume time series mainly comprises three methods of a time domain, a frequency domain and a time-frequency domain. The common multi-scale analysis of the traffic flow time series can be roughly classified into the following two categories.

(1) Spectrum analysis method: most of the spectrum analysis methods such as harmonic analysis, power spectrum analysis and improved analysis methods thereof are based on the spectrum structure of a single station time series, and utilize trigonometric function or fast Fourier transform (FFT) to extract the frequency domain characteristics of the series. The spectrum analysis method results in relatively good analysis effects for the traffic volume time series featuring regular cycles and clear spectrum structures, but it results in relatively poor analysis effects for the traffic volume time series characterized by obvious trend changes, nonlinearity, non-stationarity and quasi-periodic morphology. Meanwhile, the spectrum analysis method is a statistical method in which the decomposed spectrum information lacks clear physical images, so that the mode coupling relation and the accurate spatial-temporal characteristics of the traffic volume are difficult to obtain.

(2) Adaptive filtering method: the adaptive filtering analysis methods such as a least mean square error (LMS) filter, a root mean square (RMS) filter and a neural network method mainly adjust the weight of a given reference signal in the model calculation process constantly, so that the error between an input signal and the reference signal is reduced until convergence. The adaptive filtering method has poor processing capability for weak signals with low signal-to-noise ratio, such as traffic volume, and it requires a lot of time and series samples to support the convergence calculation process, and even fails to perform convergence in some cases.

Since the traffic volume has complex characteristics such as non-stationarity, nonlinearity and quasi-periodicity, the existing various signal analysis methods have defects in analyzing and extracting accurate trend signals, weak signals, slowly-varying quasi-periodic signals and the like in the spatial-temporal process of the traffic volume, and the nonlinearity and quasi-periodicity are leading causes of poor analysis effect of the traffic volume time series. Meanwhile, the above methods are all based on classical statistics without considering the intrinsic characteristics of the traffic flow, so that the analyzed characteristics and modes do not have clear physical images and are difficult to interpret.

Therefore, the patent application provides, while considering an intrinsic mechanism of the traffic flow, a characteristic analysis and mode decomposition method for traffic volume based on a generation-filtering mechanism, so as to realize multi-view integrated analysis and interpretation of the traffic volume, and attempt to unravel the “mystery” of the complex traffic flow from a multi-scale analysis view.

### SUMMARY

Objective: In order to clarify the uncertainty that driving patterns of drivers have brought to a traffic flow, and to define the aliasing combination and multi-scale coupling relation between traffic modes and the traffic volume. The present invention, on the basis of quantum walk, provides a characteristic modes decomposition method for traffic volume based on generation-filtering mechanism.

Technical scheme: The present invention provides a characteristic modes decomposition method for traffic volume based on generation-filtering mechanism, which comprises the following steps:

(1) taking an expressway traffic flow as a closed traffic system M, regarding each driver as a separate particle according to randomness of the driver, simulating a path trajectory by regarding each driver as a separate particle according to randomness of the driver, and obtaining corresponding traffic modes according to a probability distribution of the trajectories in the case of different parameters;

(2) obtaining time evolution of the probability distribution of the traffic flow caused by different driving modes at a station from different parameters of the quantum walk, and further converting different stations to generate a set of the expressway traffic flow modes;

(3) screening the generated traffic flow modes according to actually observed traffic volume flow data and obtaining mode structures of the traffic flow by inversion.

Further, the step (1) is implemented as follows:

assuming that the expressway traffic flow is a closed traffic system with a total number of vehicles of M, and each vehicle is expressed as {Cₘ}ₘ₌₁^{M}; the trajectory of each vehicle Cₘ is simulated by quantum walk; assuming that a set of simulation parameters of the quantum walk is {δₖ}|ₖ₌₁^{K}, the probability distribution of the trajectory of each vehicle Cₘ between stations {Sᵢ}|ᵢ₌₁^{I} is P_{δ}_{ₖ}_{C}_{ₘ}(Sᵢ, t);

the sum of probabilities of each vehicle Cₘ appearing at all stations at a fixed time point must be 1 under the condition that the parameters of the quantum walk are fixed, that is:

$${\sum }_{i = 1}^{I} P ( {S}_{i} , t , {C}_{m} , {δ}_{k} ) = 1 \qquad ( 1 )$$

under the condition that the simulation parameter δₖ of the quantum walk and the time point tⱼ are fixed, the number of vehicles appearing at a specific station Sᵢ in the closed traffic flow system is the sum of the number of vehicles Rec_{δ}_{ₖ}(S_{f}, tⱼ, Cₘ) with a higher probability of appearing at the station S, than appearing at the other stations:

$$\{ \begin{matrix}if {P}_{{δ}_{k}} ( {S}_{f} , {t}_{j} , {C}_{m} ) \geq Max ( {P}_{{δ}_{k}} ( {S}_{i} , {t}_{j} , {C}_{m} ) ) , i \neq f \\ then {Rec}_{{δ}_{k}} ( {S}_{f} , {t}_{j} , {C}_{m} ) = 1 \\ if {P}_{{δ}_{k}} ( {S}_{f} , {t}_{j} , {C}_{m} ) < Max ( {P}_{{δ}_{k}} ( {S}_{i} , {t}_{j} , {C}_{m} ) ) , i \neq f \\ then {Rec}_{{δ}_{k}} ( {S}_{f} , {t}_{j} , {C}_{m} ) = 0\end{matrix} \qquad ( 2 )$$

then the probability of the traffic flow system {Cₘ}ₘ₌₁^{M}, appearing at the station Sᵢ at the time point tⱼ is:

$${p}_{{δ}_{k}} ( {S}_{f} , {t}_{j} ) = \frac{{\sum }_{m = 1}^{M} {Rec}_{{δ}_{k}} ( {S}_{f} , {t}_{j} , {C}_{m} )}{M} \qquad ( 3 )$$

a proportion of vehicles possibly appearing at each station can be calculated to give a probability distribution p_{δ}_{ₖ}(S_{f},tⱼ) (j=1,2, . . . , T) of the traffic flow in the traffic system at a fixed time point, which will evolve over the time t; then a continuous evolution function p_{δ}_{ₖ}(S_{f}, t) of the time t can be simulated by the quantum walk, which can be regarded as a probability distribution generated by a driving state (or driving pattern) of the traffic flow {Cₘ}ₘ₌₁^{M}.

Further, the step (2) is implemented by the following formulas:

$$\begin{matrix}\{ {p}_{{δ}_{1}} ( {S}_{f} , t ) , {p}_{{δ}_{2}} ( {S}_{f} , t ) , … , {p}_{{δ}_{K}} ( {S}_{f} , t ) \} & ( 4 ) \\ \{ \begin{matrix}\{ {p}_{{δ}_{1}} ( {S}_{1} , t ) , {p}_{{δ}_{2}} ( {S}_{1} , t ) , … , {p}_{{δ}_{K}} ( {S}_{1} , t ) \} \\ \{ {p}_{{δ}_{1}} ( {S}_{2} , t ) , {p}_{{δ}_{2}} ( {S}_{2} , t ) , … , {p}_{{δ}_{K}} ( {S}_{2} , t ) \} \\ ⋮ \\ \{ {p}_{{δ}_{1}} ( {S}_{I} , t ) , {p}_{{δ}_{2}} ( {S}_{I} , t ) , … , {p}_{{δ}_{K}} ( {S}_{I} , t ) \}\end{matrix} & ( 5 )\end{matrix}$$

wherein the equation (5) is an expansion of the set of the traffic modes

$${( {p}_{{δ}_{k}} ( {S}_{i} ) \}}_{k = {1}_{i = 1}}^{{K}^{I}} ;$$

in the closed traffic system, each vehicle drives off from the traffic flow via any one of a set of stations {Sᵢ}|ᵢ₌₁^{I} at a fixed time point {tⱼ}ⱼ₌₁^{T}, therefore, the sum of probabilities of the corresponding traffic modes at all stations is 1 in the case of the fixed simulation parameters {δₖ}|ₖ₌₁^{K}, that is:

Σᵢ₌₁^{I}p_{δ}_{ₖ}(Sᵢ, tⱼ)=1. (6)

Further, the step (3) is implemented as follows:

for the traffic modes (({p_{δ}_{ₖ}(S₁, t)}ₖ₌₁^{K}, {p_{δ}_{ₖ}(S₂, t)}ₖ₌₁^{K}, . . . , {p_{δ}_{ₖ}(S₁, t)}ₖ₌₁^{K}) , a following stepwise regression equation set is established based on the observed traffic volume time series (V(S₁, t), V(S₂, t), . . . , V(S_{I}, t)):

$${\sum }_{k = 1}^{K} {α}_{ik} \times {p}_{{δ}_{k}} ( {S}_{i} , t ) = V ( {S}_{i} , t ) \qquad ( 7 )$$

wherein αᵢₖ(i=1,2, . . . ,I, k=1,2, . . . , K) indicates that there are αᵢₖ drivers driving off from the traffic flow via the station Sᵢ in a mode of p_{δ}_{ₖ} (Sᵢ) in the traffic flow system; the stepwise regression equation set is specifically expanded as follows:

$$\{ \begin{matrix}{α}_{11} {p}_{{δ}_{1}} ( {S}_{1} , t ) + {α}_{12} {p}_{{δ}_{2}} ( {S}_{1} , t ) + ⋯ + {α}_{1 k} {p}_{{δ}_{k}} ( {S}_{1} , t ) = V ( {S}_{1} , t ) \\ {α}_{21} {p}_{{δ}_{1}} ( {S}_{2} , t ) + {α}_{22} {p}_{{δ}_{2}} ( {S}_{2} , t ) + ⋯ + {α}_{2 k} {p}_{δ k} ( {S}_{2} , t ) = V ( {S}_{2} , t ) \\ ⋮ \\ {α}_{I 1} {p}_{{δ}_{1}} ( {S}_{I} , t ) + {α}_{I 2} {p}_{{δ}_{2}} ( {S}_{I} , t ) + ⋯ + {α}_{IK} {p}_{δ k} ( {S}_{I} , t ) = V ( {S}_{I} , t )\end{matrix} \qquad ( 8 )$$

the equation is further expressed in the form of a matrix as follows:

$$[ \begin{matrix}{α}_{11} & {α}_{12} & ⋯ & {α}_{1 K} \\ {α}_{21} & {α}_{22} & ⋯ & {α}_{2 K} \\ ⋮ & ⋮ & ⋱ & ⋮ \\ {α}_{I 1} & {α}_{I 2} & ⋯ & {α}_{IK}\end{matrix} ] \times [ \begin{matrix}{p}_{{δ}_{1}} ( {S}_{1} , t ) & {p}_{{δ}_{1}} ( {S}_{2} , t ) & ⋯ & {p}_{{δ}_{1}} ( {S}_{I} , t ) \\ {p}_{{δ}_{2}} ( {S}_{1} , t ) & {p}_{{δ}_{2}} ( {S}_{2} , t ) & ⋯ & {p}_{{δ}_{2}} ( {S}_{I} , t ) \\ ⋮ & ⋮ & ⋱ & ⋮ \\ {p}_{{δ}_{K}} ( {S}_{1} , t ) & {p}_{{δ}_{K}} ( {S}_{2} , t ) & ⋯ & {p}_{{δ}_{K}} ( {S}_{I} , t )\end{matrix} ] = [ \begin{matrix}V ( {S}_{1} , t ) \\ V ( {S}_{2} , t ) \\ ⋮ \\ V ( {S}_{I} , t )\end{matrix} ] . \qquad ( 9 )$$

Beneficial effects: Compared with the prior art, (1), under the constraint of observed traffic volume data, the present invention performs decomposition based on a generation-filtering mechanism to obtain traffic modes in different driving patterns, thereby revealing the complex structure and multi-mode characteristic of the traffic flow from a new view, and being an important basis for modeling, fitting, prediction and the like of the traffic volume; (2), the present invention is extension of a multi-scale analysis method of a geographic spatial-temporal process and is the “Fourier transform” of the geographic spatial-temporal process, which facilitates in-depth understanding and multi-scale interpretation of the geographic spatial-temporal process, and thus improves the cognition and regulation for the geographic spatial-temporal process; (3), based on the essence of the traffic flow, the present invention constructs a well-defined multi-scale analysis method of the traffic flow to realize the characteristic analysis and mode extraction of the traffic volume, which not only helps to analyze the multi-scale characteristic of the traffic volume, but also reveals the multi-scale coupling relation between different traffic modes and traffic volume, and thus improves the understanding and cognition of many geographical spatial-temporal processes represented by the traffic flow.

### BRIEF DESCRIPTION OF THE DRAWINGS

FIG. 1 is a flowchart of the present invention;

FIG. 2 is a schematic diagram of characteristic modes decomposition method for traffic volume based on generation-filtering mechanism;

FIG. 3 is a diagram showing the distribution of a research area and stations;

FIG. 4 is a single mode diagram of the N1 and N5 stations; and

FIG. 5 is a schematic diagram showing the distribution of characteristic mode parameters.

### DETAILED DESCRIPTION

The present invention will be further described in detail below with reference to the drawings.

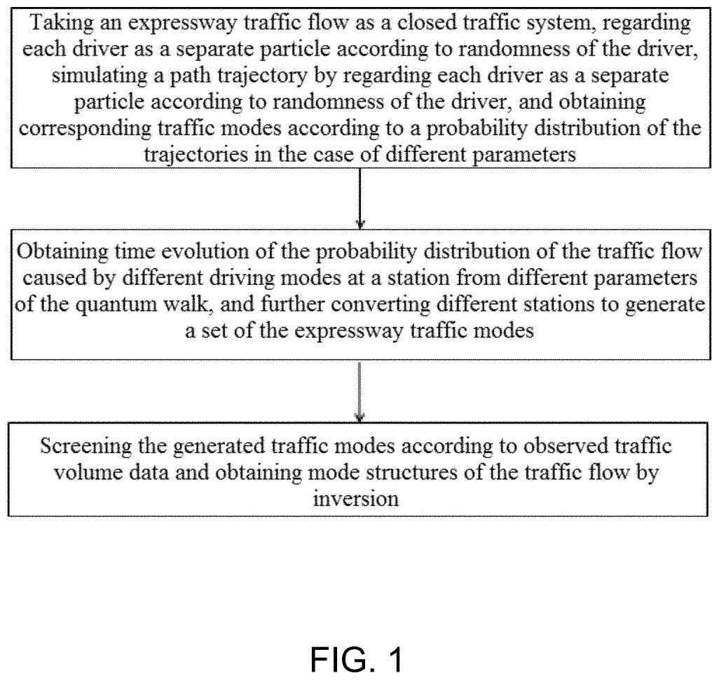

The present invention provides a characteristic modes decomposition method for traffic volume based on generation-filtering mechanism. As shown in FIG. 1, the method specifically comprises the following steps.

Step 1: Taking an expressway traffic flow as a closed traffic system M, regarding each driver as a separate particle according to randomness of the driver, simulating a path trajectory by regarding each driver as a separate particle according to randomness of the driver, and obtaining corresponding traffic modes according to a probability distribution of the trajectories in the case of different parameters; M.

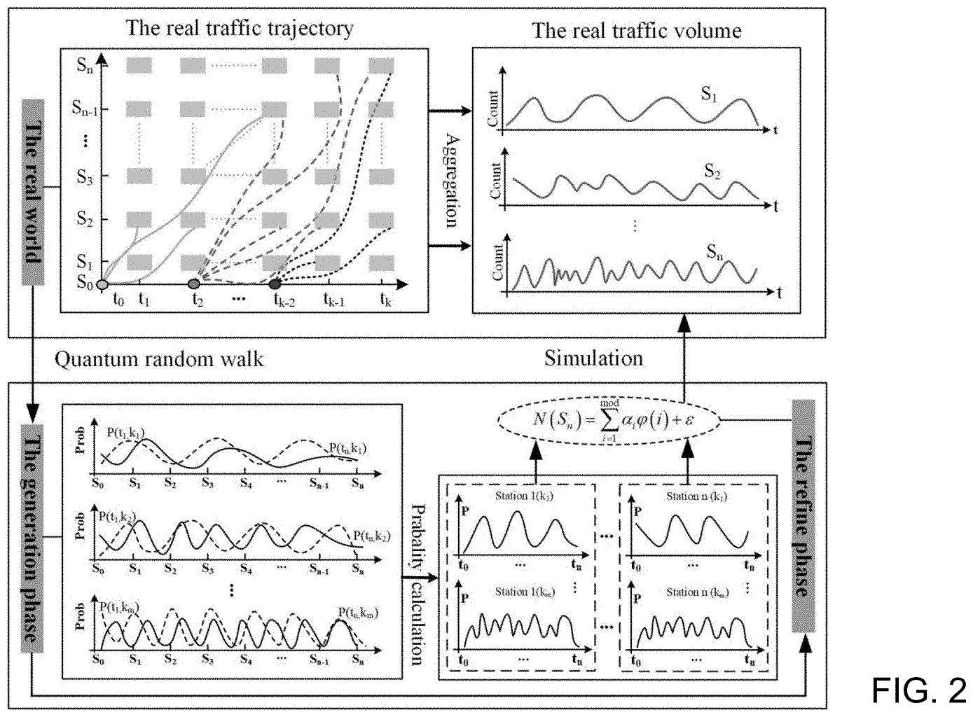

An expressway connects entry and exit stations along the route, making it possible to simulate the movement of a driver on the expressway with the transfer of an abstract particle between different stations. Assuming that the expressway traffic flow is a closed system (that is, the number of vehicles on the expressway is fixed within specific time), a possible trajectory is simulated by regarding each driver as a separate particle according to the randomness of the driver. Then a series of different trajectories will be simulated in the traffic flow system. Further, a series of possible traffic modes can be obtained according to a probability distribution of the trajectories in the case of different parameters. However, a real traffic flow can be considered to be generated by different drivers adopting different driving patterns. Therefore, the generated traffic modes can be screened according to observed traffic volume data, and thus mode structures of the traffic volume can be inversed. Therefore, the method comprises two parts of traffic mode generation and mode filtering. The schematic diagram of decomposition of traffic flow characteristic modes is shown in FIG. 2.

Assuming that the expressway traffic flow is a closed system with a total number of vehicles of M, and each vehicle is expressed as {Cₘ}ₘ₌₁^{M}. The trajectory of each vehicle Cₘ Cₘcan be simulated by quantum walk; assuming that a set of simulation parameters of quantum walk is ^{{δ}ₖ}|ₖ₌₁^{K}, the probability distribution of the trajectory of each vehicle Cₘ between stations {Sᵢ}|=i=1^{I} (i.e., the probability of appearing at each station) can be expressed as P_{δ}_{ₖ}_{C}_{ₘ} (Sᵢ, t), which is a function of time t.

Each vehicle Cₘ may exit from any one of I stations under the condition that the parameters of the quantum walk are fixed, so the sum of probabilities of its appearing at all stations at a fixed time point must be 1, that is:

$${\sum }_{i = 1}^{I} P ( {S}_{i} , t , {C}_{m} , {δ}_{k} ) = 1 \qquad ( 1 )$$

As can be seen from the basic assumption of the quantum walk, when the system is not observed, a walker will appear at a plurality of possible positions with a certain probability, but the state of the walker will collapse to a state with the highest probability once the system is observed. Therefore, under the condition that the simulation parameter δₖ of the quantum walk and the time point tⱼ are fixed, the number of vehicles appearing at a specific station Sᵢ in the closed traffic flow system is the sum of the number of vehicles Rec_{δ}_{ₖ}(S_{f}, tⱼ, Cₘ) with a higher probability of appearing at the station Sᵢ than appearing at the other stations. To this end, an expression is established as follows:

$$\{ \begin{matrix}if {P}_{{δ}_{k}} ( {S}_{f} , {t}_{j} , {C}_{m} ) \geq Max ( {P}_{{δ}_{k}} ( {S}_{i} , {t}_{j} , {C}_{m} ) ) , i \neq f \\ then {Rec}_{{δ}_{k}} ( {S}_{f} , {t}_{j} , {C}_{m} ) = 1 \\ if {P}_{{δ}_{k}} ( {S}_{f} , {t}_{j} , {C}_{m} ) < Max ( {P}_{{δ}_{k}} ( {S}_{i} , {t}_{j} , {C}_{m} ) ) , i \neq f \\ then {Rec}_{{δ}_{k}} ( {S}_{f} , {t}_{j} , {C}_{m} ) = 0\end{matrix} \qquad ( 2 )$$

Then the probability of the closed traffic flow system {Cₘ}ₘ₌₁^{M} appearing at the station Sᵢ at the time point tⱼ is expressed as follows:

$${p}_{{δ}_{k}} ( {S}_{f} , {t}_{j} ) = \frac{{\sum }_{m = 1}^{M} {Rec}_{{δ}_{k}} ( {S}_{f} , {t}_{j} , {C}_{m} )}{M} \qquad ( 3 )$$

A proportion of vehicles possibly appearing at each station can be calculated to give a probability distribution p_{δ}_{ₖ}(S_{f}, tⱼ), (j=1,2, . . . , T) of the traffic flow in the traffic system at a fixed time point, which will evolve over the time t; then a continuous evolution function p_{δ}_{ₖ}(S_{f}, t) of the time t can be simulated by the quantum walk, which can be regarded as a probability distribution generated by a driving state (or driving pattern) of the traffic flow {Cₘ}ₘ₌₁^{M}.

Step 2: Obtaining time evolution of the probability distribution of the traffic volume caused by different driving patterns at a station from different parameters of the quantum walk, and then performing the same for other different stations to generate a set of expressway traffic modes.

A series of time evolutions of the probability distribution of the traffic volume caused by different driving patterns at the station S_{f} can be obtained from different parameters {δₖ}|ₖ₌₁^{K} of the quantum walk:

{p_{δ}_{₁}(S_{f}, t), p_{δ}_{₂}(S_{f}, t), . . . , p_{δ}_{_{K}}(S_{f}, t)} (4)

Then the same operation is applied to other different stations to generate a set of a series of different traffic modes

$${\{ {p}_{{δ}_{k}} ( {S}_{i} ) \}}_{k = {1}_{i = 1}}^{{K}^{I}}$$

at different stations in the expressway traffic flow, which is expressed as follows:

$$\{ \begin{matrix}\{ {p}_{{δ}_{1}} ( {S}_{1} , t ) , {p}_{{δ}_{2}} ( {S}_{1} , t ) , … , {p}_{{δ}_{K}} ( {S}_{1} , t ) \} \\ \{ {p}_{{δ}_{1}} ( {S}_{2} , t ) , {p}_{{δ}_{2}} ( {S}_{2} , t ) , … , {p}_{{δ}_{K}} ( {S}_{2} , t ) \} \\ ⋮ \\ \{ {p}_{{δ}_{1}} ( {S}_{I} , t ) , {p}_{{δ}_{2}} ( {S}_{I} , t ) , … , {p}_{{δ}_{K}} ( {S}_{I} , t ) \}\end{matrix} \qquad ( 5 )$$

The set of probability distributions of the traffic flow can be considered as a series of possible traffic modes simulated by the quantum walk. In this traffic system, each vehicle will inevitably drive off from the traffic flow via any one of a set of stations {Sᵢ}|ᵢ₌₁^{I} at a fixed time point {tⱼ}ⱼ₌₁^{T}. Therefore, the sum of probabilities of the corresponding traffic modes at all stations is 1 in the case of the fixed simulation parameters {δₖ}ₖ₌₁^{K}, that is:

$${\sum }_{i = 1}^{I} {p}_{{δ}_{k}} ( {S}_{i} , {t}_{j} ) = 1 \qquad ( 6 )$$

Step 3: Screening the generated traffic modes according to observed traffic volume data and obtaining mode structures of the traffic flow by inversion.

The traffic modes generated in step 2 can be considered as all possible traffic modes generated according to the characteristics of the quantum walk. However, in the real traffic flow, the observed traffic flow may be formed by aliasing of only partial traffic modes due to various constraints. Therefore, it is necessary to filter all the above possible traffic modes according to the observed traffic volume data to reflect the complex characteristics and multi-mode structures of different traffic flows.

For the traffic modes ({p_{δ}_{ₖ}(S₁, t)}ₖ₌₁^{K}, {p_{δ}_{ₖ}(S₂, t)}ₖ₌₁^{K}, . . . , {p_{δ}_{ₖ}, (S_{I}, t)}ₖ₌₁^{K}) generated in the step 2, a following stepwise regression equation set is established based on the observed traffic volume time series (V (S₁, t),V(S₂,t), . . . ,V(S_{I},t)):

$${\sum }_{k = 1}^{K} {α}_{ik} \times {p}_{{δ}_{k}} ( {S}_{i} , t ) = V ( {S}_{i} , t ) \qquad ( 7 )$$

wherein αᵢₖ(i=1,2, . . . , I, k=1,2, . . . , K) indicates that there are αᵢₖ drivers drive off from the traffic flow via the station Sᵢ in a mode of p_{δ}_{ₖ}(Sᵢ) in the traffic flow system. The stepwise regression equation set (7) is specifically expanded as follows:

$$\{ \begin{matrix}{α}_{11} {p}_{{δ}_{1}} ( {S}_{1} , t ) + {α}_{12} {p}_{{δ}_{2}} ( {S}_{1} , t ) + ⋯ + {α}_{1 k} {p}_{{δ}_{k}} ( {S}_{1} , t ) = V ( {S}_{1} , t ) \\ {α}_{21} {p}_{{δ}_{1}} ( {S}_{2} , t ) + {α}_{22} {p}_{{δ}_{2}} ( {S}_{2} , t ) + ⋯ + {α}_{2 k} {p}_{δ k} ( {S}_{2} , t ) = V ( {S}_{2} , t ) \\ ⋮ \\ {α}_{I 1} {p}_{{δ}_{1}} ( {S}_{I} , t ) + {α}_{I 2} {p}_{{δ}_{2}} ( {S}_{I} , t ) + ⋯ + {α}_{IK} {p}_{δ k} ( {S}_{I} , t ) = V ( {S}_{I} , t )\end{matrix} \qquad ( 8 )$$

The equation is further expressed in the form of a matrix as follows:

$$[ \begin{matrix}{α}_{11} & {α}_{12} & ⋯ & {α}_{1 K} \\ {α}_{21} & {α}_{22} & ⋯ & {α}_{2 K} \\ ⋮ & ⋮ & ⋱ & ⋮ \\ {α}_{I 1} & {α}_{I 2} & ⋯ & {α}_{IK}\end{matrix} ] \times [ \begin{matrix}{p}_{{δ}_{1}} ( {S}_{1} , t ) & {p}_{{δ}_{1}} ( {S}_{2} , t ) & ⋯ & {p}_{{δ}_{1}} ( {S}_{I} , t ) \\ {p}_{{δ}_{2}} ( {S}_{1} , t ) & {p}_{{δ}_{2}} ( {S}_{2} , t ) & ⋯ & {p}_{{δ}_{2}} ( {S}_{I} , t ) \\ ⋮ & ⋮ & ⋱ & ⋮ \\ {p}_{{δ}_{K}} ( {S}_{1} , t ) & {p}_{{δ}_{K}} ( {S}_{2} , t ) & ⋯ & {p}_{{δ}_{K}} ( {S}_{I} , t )\end{matrix} ] = [ \begin{matrix}V ( {S}_{1} , t ) \\ V ( {S}_{2} , t ) \\ ⋮ \\ V ( {S}_{I} , t )\end{matrix} ] \qquad ( 9 )$$

In the process of generating a single mode at a single station, the key point is that in the case of given parameters, a walker starts from a fixed station and conducts the quantum walk on a basic framework composed of an adjacent matrix (topological structure) of an expressway network in a research area, and the dynamic evolution over time of the distribution probability of vehicles at the single station is generated.

In the quantum walk, the dynamic evolution of the distribution probability of vehicles is controlled by Hamiltonian H and can be represented by the adjacency matrix of the expressway network. For an expressway traffic with a set of stations of {Sᵢ}|ᵢ₌₁^{I}, the Hamiltonian can be expressed as:

$$H = [ \begin{matrix}0 & 1 & 0 & ⋯ & 0 & 0 \\ 1 & 0 & 1 & ⋯ & 0 & 0 \\ 0 & 1 & 0 & ⋯ & 0 & 0 \\ ⋮ & ⋮ & ⋮ & ⋱ & ⋮ & ⋮ \\ 0 & 0 & 0 & ⋯ & 1 & 0\end{matrix} ] \qquad ( 10 )$$

The probability evolution operator of the quantum random walk is U(t)=e^{-iHt}, and in the initial state, is ψ(0). Then in the case of parameters {δₖ}|ₖ₌₁^{K}, the state ψ_{δ}_{ₖ}(t) of the walker {Cₘ}ₘ₌₁^{M} at the time point t can be expressed as:

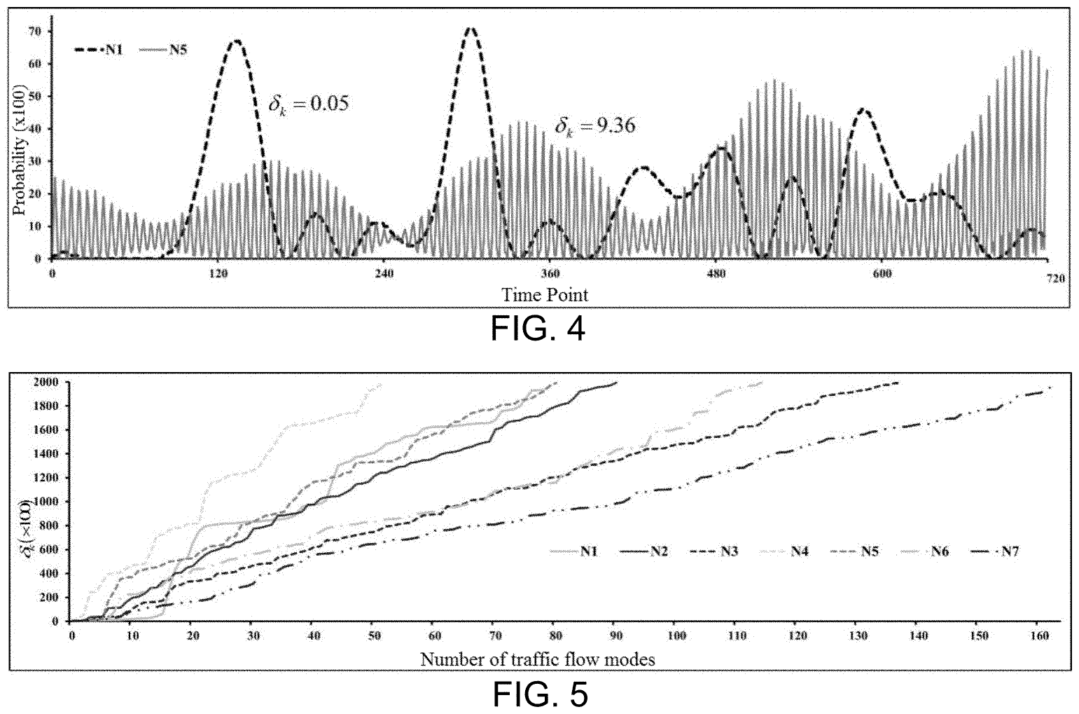

ψ_{δ}_{ₖ}(t)=U(t)ψ(0) (11)

wherein ψ_{δ}_{ₖ}(t) is the probability amplitude with its square being {p_{δ}_{ₖ}(Sᵢ)}ᵢ₌₁^{I}, and represents the probability of the walker appearing at a certain station at the time point t. In the present patent application, polynomial expansion is adopted to approach ψ_{δ}_{ₖ}(t), thereby acquiring solution for ψ_{δ}_{ₖ}(t). Based on the above specific process and in consideration of the parameter, the single mode at the Ni station (δₖ=0.05) and the N5 station (δₖ=9.36) is shown in FIG. 4.

In the quantum walk, the adjacency matrix (topological structure) of the expressway network in the research area defines the possible positions at which the walker may appear, namely 7 typical stations selected for the experimental verification of the patent. The simulation parameter δₖ is the only parameter of the quantum walk, which defines the evolution process of the probability distribution of walkers appearing at each station. Meanwhile, the expressway traffic flow is generated by aliasing of a plurality of traffic modes, so a single mode cannot reveal the overall complex mode structure of the expressway traffic flow. Therefore, the parameter δₖ of the quantum walk parameter of each station is constantly adjusted: 2000 quantum walks are performed on the expressway network in the research area, and δₖ is increased from 0.01 to 20 at 0.01 intervals. Finally, all possible traffic modes of 7 stations are generated.

Screening the traffic modes ({p_{δ}_{ₖ}(S₁, t)}ₖ₌₁^{K}, {p_{δ}_{ₖ}(S₂, t)}ₖ₌₁^{K}, . . . , {p_{δ}_{ₖ}, (S_{I}, t)}ₖ₌₁^{K}) using the observed traffic volume time series V(Sᵢ, t) based on the stepwise regression is a key step for realizing the traffic mode decomposition. Therefore, a stepwise regression equation is established as follows:

$$V ( {S}_{i} , t ) ∼ stepwize ( {\sum }_{k = 1}^{K} {α}_{ik} \times {p}_{{δ}_{k}} ( {S}_{i} , t ) ) \qquad ( 12 )$$

Based on the equation (12), under the constraints of a certain criterion (such as criterion AIC or BIC) and the observed traffic volume time series, a subset of traffic modes p_{δ}_{_{q}}(Sᵢ, t)(q∈Q={q₁, q₂, . . . q_{q′},}⊆{1,2, . . . , K}) is selected from all possible traffic modes ({p_{δ}_{ₖ}(S₁, t)}ₖ₌₁^{K}, {p_{δ}_{ₖ}(S₂, t)}ₖ₌₁^{K}, . . . , {p_{δ}_{ₖ}, (S_{I}, t)}ₖ₌₁^{K}), which is the characteristic mode of the traffic flow.

In the present patent application, traffic volume time series data of vehicles driving off from the Shanghai-Nanjing expressway via the 7 typical expressway entry and exit stations on the Nanjing-Changzhou section (Tangshan station (N1), Jurong station (N2), Heyang station

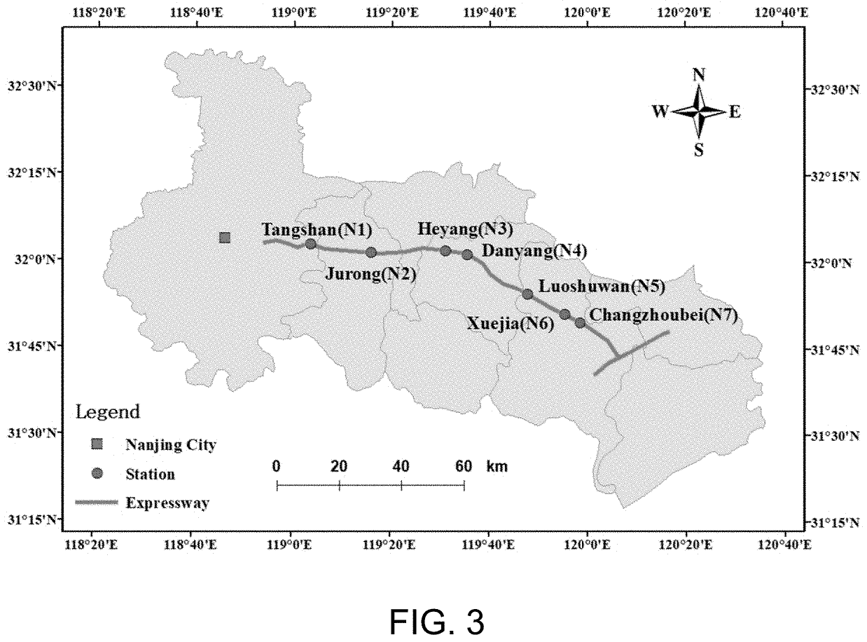

(N3), Danyang station (N4), Luoshuwan station (N5), Xuejia station (N6) and Changzhoubei station (N7)) from December 1 to 5, 2015 are collected as experimental data (all driving into the expressway from Nanjing station), with the data collection time frequency being 10 minutes. The research area and station distribution are shown in FIG. 3.

According to the above data, the traffic mode generation and filtering of the traffic flow based on 7 typical expressway entry and exit stations on the Nanjing-Changzhou section of Shanghai-Nanjing expressway are completed, and the characteristic mode decomposition of the traffic volume is realized. The distribution of characteristic mode parameters of all stations is shown in FIG. 5. In the 7 stations, the number of traffic modes ranges from 54 (N4) to 165 (N7), indicating that the drivers who drive off from the expressway via the N4 station take a simpler driving pattern, the reason of which is that the traffic flow of the N4 station is larger, and most of the drivers will drive in a constant speed or take vehicle-following driving mode instead of such driving patterns as overtaking. There are fewer vehicles at the N7 station, which provides enough space for drivers to change their driving patterns. Therefore, the driving mode at the N7 station is more complex. In addition, the traffic mode parameters of the Ni and N4 stations fluctuate sharply, while those of the rest five stations go flat. This indicates that the traffic modes of the Ni and N4 stations are not distributed uniformly. If a section has a smaller curve slope (a slower curve), the traffic modes are in an aggregation state, otherwise, the traffic modes are in a dispersion state that reflects distinctive driving patterns of drivers. The traffic modes of the rest five stations are distributed uniformly with various driving patterns included.

1. A characteristic modes decomposition method for traffic volume based on generation-filtering mechanism, comprising the following steps:
(1) taking an expressway traffic flow as a closed traffic system M, regarding each driver as a separate particle according to randomness of the driver, simulating a path trajectory, and obtaining corresponding traffic modes according to a probability distribution of the trajectories in the case of different parameters;
(2) obtaining time evolution of the probability distribution of the traffic flow caused by different driving modes at a station from different parameters of the quantum walk, and further converting different stations to generate a set of the expressway traffic modes;
(3) screening the generated traffic modes according to observed traffic volume data and obtaining mode structures of the traffic flow by inversion.

2. The characteristic modes decomposition method according to claim 1, wherein the step (1) is implemented as follows:
assuming that the expressway traffic flow is a closed traffic system with a total number of vehicles of M, and each vehicle is expressed as {Cₘ}ₘ₌₁^{M}; each vehicle Cₘ is simulated by quantum walk; assuming that a set of simulation parameters of the quantum walk is {δₖ}ₖ₌₁^{K}, the probability distribution of the trajectory of each vehicle Cₘ between stations {Sᵢ}|ᵢ₌₁^{I} is P_{δ}_{ₖ}_{C}_{ₘ}(Sᵢ, t);
a sum of probabilities of each vehicle Cₘ appearing at all stations at a fixed time point must be 1 under a condition that the parameters of the quantum walk are fixed, that is:
$${\sum }_{i = 1}^{I} P ( {S}_{i} , t , {C}_{m} , {δ}_{k} ) = 1 \qquad ( 1 )$$
under the condition that the simulation parameter δₖ of the quantum walk and the time point t₁ are fixed, the number of vehicles appearing at a specific station Sᵢ in the closed traffic flow system is a sum of the number of vehicles Rec_{δ}_{ₖ}(S_{f}, t_{f}, Cₘ) with a higher probability of appearing at the station Sᵢ than appearing at the other stations:
$$\{ \begin{matrix}if {P}_{{δ}_{k}} ( {S}_{f} , {t}_{j} , {C}_{m} ) \geq Max ( {P}_{{δ}_{k}} ( {S}_{i} , {t}_{j} , {C}_{m} ) ) , i \neq f \\ then {Rec}_{{δ}_{k}} ( {S}_{f} , {t}_{j} , {C}_{m} ) = 1 \\ if {P}_{{δ}_{k}} ( {S}_{f} , {t}_{j} , {C}_{m} ) < Max ( {P}_{{δ}_{k}} ( {S}_{i} , {t}_{j} , {C}_{m} ) ) , i \neq f \\ then {Rec}_{{δ}_{k}} ( {S}_{f} , {t}_{j} , {C}_{m} ) = 0\end{matrix} \qquad ( 2 )$$
then a probability of the traffic flow system {Cₘ}ₘ₌₁^{M} appearing at the station Sᵢ at the time point tⱼ is:
$${p}_{{δ}_{k}} ( {S}_{f} , {t}_{j} ) = \frac{{\sum }_{m = 1}^{M} {Rec}_{{δ}_{k}} ( {S}_{f} , {t}_{j} , {C}_{m} )}{M} \qquad ( 3 )$$
a proportion of vehicles possibly appearing at each station can be calculated to give a probability distribution p_{δ}_{ₖ}(S_{f}, tⱼ), (j=1,2, . . . , T) of the traffic flow in the traffic system at a fixed time point, which will evolve over the time t; then a continuous evolution function p_{δ}_{ₖ}(S_{f}, t) of the time t can be simulated by the quantum walk, which can be regarded as a probability distribution generated by a driving state (or driving pattern) of the traffic flow {Cₘ}ₘ₌₁^{M}.

3. The characteristic modes decomposition method according to claim 1, wherein the step (2) is implemented by the following formulas:
$$\begin{matrix}\{ {p}_{{δ}_{1}} ( {S}_{f} , t ) , {p}_{{δ}_{2}} ( {S}_{f} , t ) , … , {p}_{{δ}_{K}} ( {S}_{f} , t ) \} & ( 4 ) \\ \{ \begin{matrix}\{ {p}_{{δ}_{1}} ( {S}_{1} , t ) , {p}_{{δ}_{2}} ( {S}_{1} , t ) , … , {p}_{{δ}_{K}} ( {S}_{1} , t ) \} \\ \{ {p}_{{δ}_{1}} ( {S}_{2} , t ) , {p}_{{δ}_{2}} ( {S}_{2} , t ) , … , {p}_{{δ}_{K}} ( {S}_{2} , t ) \} \\ ⋮ \\ \{ {p}_{{δ}_{1}} ( {S}_{I} , t ) , {p}_{{δ}_{2}} ( {S}_{I} , t ) , … , {p}_{{δ}_{K}} ( {S}_{I} , t ) \}\end{matrix} & ( 5 )\end{matrix}$$
wherein the equation (5) is an expansion of the set of the traffic modes {p_{δ}_{ₖ}(Sᵢ)}ₖ₌₁_{ᵢ₌₁}^{K}^{^{I}}; in the closed traffic system, each vehicle drives off from the traffic flow via any one of a set of stations {Sᵢ}|ᵢ₌₁^{I} at a fixed time point {tⱼ}ⱼ₌₁^{T}, therefore, the sum of probabilities of the corresponding traffic modes at all stations is 1 in the case of the fixed simulation parameters {δₖ}|ₖ₌₁^{K}, that is:
Σᵢ₌₁^{I}p_{δ}_{ₖ}(Sᵢ, tⱼ)=1 (6)

4. The characteristic modes decomposition method according to claim 1, wherein the step (3) is implemented as follows:
for the traffic modes ({p_{δ}_{ₖ}(S₁, t)}ₖ₌₁^{K}, {p_{δ}_{ₖ}(S₂, t)}ₖ₌₁^{K}, . . . , {p_{δ}_{ₖ}, (S_{I}, t)}ₖ₌₁^{K}), a following stepwise regression equation set is established based on the observed traffic volume time series (V(S₁, t), V(S₂, t), . . . , V(S_{I}, t)):
$${\sum }_{k = 1}^{K} {α}_{ik} \times {p}_{{δ}_{k}} ( {S}_{i} , t ) = V ( {S}_{i} , t ) \qquad ( 7 )$$
wherein αᵢₖ(i=1,2, . . . , I, k=1,2, . . . , K) indicates that there are αᵢₖ drivers driving off from the traffic flow via the station Sᵢ in a mode of p_{δ}_{ₖ}(Sᵢ) in the traffic flow system; the stepwise regression equation set is specifically expanded as follows:
$$\{ \begin{matrix}{α}_{11} {p}_{{δ}_{1}} ( {S}_{1} , t ) + {α}_{12} {p}_{{δ}_{2}} ( {S}_{1} , t ) + ⋯ + {α}_{1 k} {p}_{{δ}_{k}} ( {S}_{1} , t ) = V ( {S}_{1} , t ) \\ {α}_{21} {p}_{{δ}_{1}} ( {S}_{2} , t ) + {α}_{22} {p}_{{δ}_{2}} ( {S}_{2} , t ) + ⋯ + {α}_{2 k} {p}_{δ k} ( {S}_{2} , t ) = V ( {S}_{2} , t ) \\ ⋮ \\ {α}_{I 1} {p}_{{δ}_{1}} ( {S}_{I} , t ) + {α}_{I 2} {p}_{{δ}_{2}} ( {S}_{I} , t ) + ⋯ + {α}_{IK} {p}_{δ k} ( {S}_{I} , t ) = V ( {S}_{I} , t )\end{matrix} \qquad ( 8 )$$
the equation is further expressed in the form of a matrix as follows:
$$[ \begin{matrix}{α}_{11} & {α}_{12} & ⋯ & {α}_{1 K} \\ {α}_{21} & {α}_{22} & ⋯ & {α}_{2 K} \\ ⋮ & ⋮ & ⋱ & ⋮ \\ {α}_{I 1} & {α}_{I 2} & ⋯ & {α}_{IK}\end{matrix} ] \times [ \begin{matrix}{p}_{{δ}_{1}} ( {S}_{1} , t ) & {p}_{{δ}_{1}} ( {S}_{2} , t ) & ⋯ & {p}_{{δ}_{1}} ( {S}_{I} , t ) \\ {p}_{{δ}_{2}} ( {S}_{1} , t ) & {p}_{{δ}_{2}} ( {S}_{2} , t ) & ⋯ & {p}_{{δ}_{2}} ( {S}_{I} , t ) \\ ⋮ & ⋮ & ⋱ & ⋮ \\ {p}_{{δ}_{K}} ( {S}_{1} , t ) & {p}_{{δ}_{K}} ( {S}_{2} , t ) & ⋯ & {p}_{{δ}_{K}} ( {S}_{I} , t )\end{matrix} ] = [ \begin{matrix}V ( {S}_{1} , t ) \\ V ( {S}_{2} , t ) \\ ⋮ \\ V ( {S}_{I} , t )\end{matrix} ] \qquad ( 9 )$$
